(19) United States
(12) Patent Application Publication
(10) Pub. No.: US 2013/0207016 A1
(43) Pub. Date: Aug. 15, 2013

(54) Solenoid Valve

(71) Applicant: Valentin Schubitschew, Tamm (DE)

(72) Inventor: Valentin Schubitschew, Tamm (DE)

(73) Assignee: Robert Bosch GmbH, Stuttgart (DE)

(21) Appl. No.: 13/640,879

(22) PCT Filed: Feb. 8, 2011
(86) PCT No.: PCT/EP2011/051776

§ 371 Date: Jan. 23, 2013

(30) Foreign Application Priority Data
Apr. 14, 2010 (DE) 10 2010 003 958.6

(51) Int. Cl. F16K 31/02

(52) U.S. Cl. CPC F16K 31/02
USPC 251/129.15

(57) ABSTRACT

A magnet valve includes (i) a magnet armature which is arranged in an axially movable manner in a valve housing and (ii) at least one valve element which is operatively connected to the magnet armature. The valve element is movable by means of the magnet armature so as to open up or close off at least one valve seat of the magnet valve, and at least one flow path is formed between the valve housing and the magnet armature and/or the valve element. A flow throttling element is provided in the flow path. The flow throttling element is arranged between a first end stop, which is formed in particular by the magnet armature, and a second end stop, which is formed in particular by the valve element.

The invention relates to a solenoid valve comprising an armature that is arranged in an axially displaceable manner in a valve housing and comprising at least one valve element that is operatively connected to the armature, wherein the valve element can be displaced by means of the armature to open or close at least one valve seat of the solenoid valve, and wherein at least one flow path is embodied between the valve housing and the armature and/or the valve element.

### PRIOR ART

Solenoid valves of the type mentioned in the introduction are known from the prior art. The armature of the solenoid valve can be influenced, for example, by at least one coil in such a manner that said armature is axially displaced and in so doing the valve element is arranged in order to open or close the valve seat. The armature and/or the valve element can, in addition, be operatively connected to a spring element that generates a resilient force that urges the armature and/or the valve element in the direction of the respective idle position and/or starting position. In so doing, the idle position can be an open position in which the valve seat is at least partially opened by the valve element, or a closed position in which the valve element closes the valve seat. In the first case, the solenoid valve is a de-energized, open solenoid valve, in the latter case a de-energized, closed solenoid valve. The solenoid valve can, for example, be embodied as a high pressure switching valve (HSV) and can be used in a device for assisting the driver. The device for assisting the driver is, for example, an ESP, ASR or an ABS system.

The flow path is provided in order to render it possible during the displacement of the armature and/or of the valve element to compensate the pressure between fluid chambers that are located on different sides of the armature. This flow path is situated between the valve housing and the armature and/or the valve element. Consequently, as the armature is displaced, the fluid located in the solenoid valve can flow along the flow path and in so doing flow from one of the fluid chambers into another of the fluid chambers. Owing to the fact that the flow path generally comprises only a comparatively small volume, i.e. the spaced disposition between the valve housing and the armature and/or the valve element is relatively small, the fluid that is flowing along the flow path is greatly accelerated. As a result, as the armature and/or the valve element is displaced, fluid flows along the flow path at a high flow rate. If, in so doing, the fluid impacts a hydraulic stop, then the fluid is suddenly decelerated, causing a high pressure at this site. The impacting of the fluid against the hydraulic stop (for example, a region of the armature or of the valve seat) causes pressure waves to occur and consequently noises that can be perceived as unpleasant.

This is particularly the case if the solenoid valve is a multi-stage valve, in particular a two-stage valve, and in this respect comprises a preliminary stage and a main stage, and/or if the solenoid valve comprises a long stroke. In the case of high differential pressures between an inlet and an outlet of the solenoid valve of, for example, ≧30 bar, only the preliminary stage can be opened. As a consequence, the differential pressure reduces. When the differential pressure has reduced sufficiently, the main stage is automatically opened, for example, in the case of a differential pressure of ≦10 bar. The disturbing noises occur, in particular, as the main stage is opened or closed in the pressure-less state.

### DISCLOSURE OF THE INVENTION

In contrast thereto, the solenoid valve having the features mentioned in claim 1 has the advantage of reducing the noise that is generated as the solenoid valve is switched over and/or as the armature and/or the valve element is displaced. At the same time, the switching time of the solenoid valve is not to be influenced or at least not to be substantially influenced. This is achieved in accordance with the invention using a flow restricting element that is provided in the flow path and is arranged between a first end stop, which is embodied in particular by the armature, and a second end stop, which is embodied in particular by the valve element. The flow restricting element creates a hydraulic damping effect in the flow path. In this manner, the flow rate of the fluid is reduced, so that pressure waves are prevented from forming and/or from being transmitted in the fluid and/or the amplitude of the pressure waves is reduced. The flow restricting element is preferably arranged mounted between the first and the second end stop in such a manner as to be able to move freely, i.e. in an axially displaceable manner between the first and the second end stop. However, the extent to which the flow restricting element can be displaced is limited by the two end stops. In so doing, the first stop is preferably embodied by the armature and the second end stop is preferably embodied by the valve element. The flow restricting element creates a noticeable damping effect by means of its restricting effect in the disrupted flow in the flow path, i.e. between the valve housing and the armature and/or the valve element; consequently, the pressure wave that occurs by virtue of the armature and/or the valve element being displaced is consequently transmitted in a restricted manner.

The extent of the damping effect that is created by the flow restricting element can be adjusted, inter alia, by way of the spaced disposition between the first and the second end stop. If the flow restricting element is fixedly held between the two end stops, then the restricting effect of the flow restricting element as the armature and/or the valve element is displaced commences immediately. If, on the other hand, the first and the second end stop are at such a mutually spaced disposition that the flow restricting element is not permanently both at the first end stop and also at the second end stop, but can move between these two, then the flow restricting element commences to exert its restricting effect only when the armature and/or the valve element have been displaced to such an extent that the flow restricting element has come into contact either with the first or the second end stop. The flow restricting element is then only axially displaceable if it is not simultaneously in contact with the first and the second end stop but only in contact with one of the two end stops. In the case of an embodiment of this type, the flow restricting element is not fixedly held between the end stops, but is, in fact, moveable and/or displaceable between said end stops.

The flow restricting element is preferably embodied in a geometrically simple manner, for example as an annular disk. Said flow restricting element can be installed in the solenoid valve without any structural changes to the existing series production parts. The additional flow restricting element is accordingly an extremely cost-efficient and effective solution for reducing the noises generated in the solenoid valve. When assembling the solenoid valve, it is only necessary to include one additional working step, i.e. to introduce the flow restricting element into the solenoid valve.

A development of the invention provides that the valve element comprises at least one closing element allocated to the valve seat, wherein, in particular, an intermediate piece of the valve element produces an operative connection between the armature and the closing element. The closing element is a component of the valve element. It cooperates with the valve seat, in order either to open or close said valve seat. In the first case, the closing element is at a spaced disposition from the valve seat, preferably in the axial direction of the solenoid valve, and in the latter case, the closing element lies on the valve seat in a sealing manner. Preferably, a closing element that is associated in each case with the valve element is provided for each valve seat of the solenoid valve. The valve element can comprise, in addition, the intermediate piece, by means of which the operative connection between the armature and the closing element is produced. This means that as the armature is displaced, this displacement is at least partially transmitted to the closing element. However, the closing element can also be fastened to the armature, so that it is not necessary to provide an intermediate piece. If a plurality of closing elements is provided, then, for example, one of the closing elements can be fastened to the armature and another of the closing elements operatively connected to said armature.

A development of the invention provides that the valve element comprises a plurality of closing elements, wherein each closing element is provided for opening or closing a valve seat respectively. In so doing, it is irrelevant whether the valve seats are switched with regard to the flow sequentially one after the other or in parallel one with the other. In the first case, the solenoid valve is embodied as a multi-stage solenoid valve.

A development of the invention provides that one of the closing elements is allocated to a preliminary stage of the solenoid valve and another of the closing elements is allocated to a main stage of the solenoid valve. Accordingly, the solenoid valve is a multi-stage valve, in particular a two-stage valve. As already mentioned above, in the case of high differential pressures between an inlet and an outlet of the solenoid valve, initially the closing element of the preliminary stage is displaced in order to open the corresponding valve seat. In this manner, a flow connection is provided between the inlet and the outlet of the solenoid valve, whereby the differential pressure reduces. If the differential pressure has reduced sufficiently, then the closing element of the main stage is subsequently displaced, so that this also opens the corresponding valve seat.

A development of the invention provides that the intermediate piece encompasses the armature at least in regions and/or is fastened thereto. The intermediate piece therefore comprises, for example, retaining arms, which engage the armature, or said intermediate piece is embodied at least in regions in the form of a sleeve in order to encompass the armature. Preferably, the intermediate piece is fixedly connected to the armature, so that any displacement movement of the armature acts directly on the intermediate piece and displaces said intermediate piece accordingly.

A development of the invention provides that the flow restricting element is embodied as an annular disk. In so doing, the annular disk comprises a circular cross-section as seen in the axial direction of the solenoid valve and a central cut-out that likewise has a circular cross-section. The annular disk is preferably arranged in such a manner that the armature engages through the central cut-out at least in regions. Thus, the annular disk is mounted in this respect on the armature so that a guide is provided in the axial direction. The annular disk can comprise at least one axial bore hole by means of which dimensioning it is possible to adjust the restricting effect of the annular disk. In place of or in addition to the axial bore hole, it is also possible to provide at least one edge-open, axial through-going cut-out on the outer or on the inner contour of the annular disk, which axial through-going cut-out is embodied, for example, as a notch.

A development of the invention provides that the first end stop is embodied by an annular step of the armature and/or the second end stop is provided on an end face of the intermediate piece. In so doing, the annular step is embodied by a change in the size of the cross-section of the armature. Preferably, the armature is circular in the cross-section as seen in the axial direction of the solenoid valve, so that the annular step is provided in the form of a change in the diameter of the armature. If the flow restricting element is embodied as an annular disk, then the region of the comparatively smaller diameter of the armature can engage through the central cut-out of the annular disk and the armature can simultaneously provide the first end stop in the region of the diameter change and/or in the region of the annular step. In addition or as an alternative thereto, the second end stop is provided on the end face of the intermediate piece.

A development of the invention provides that the flow restricting element comprises a flow through-passage between its outer wall and the valve housing and/or between its inner wall and the armature. As a result, the flow restricting element is at such a spaced disposition from the valve housing and/or the armature, that the flow through-passage is provided, through which flow through-passage the fluid can flow when the armature and/or the valve element is displaced. The flow restricting element is responsible in this respect only for restricting the fluid flow, reducing thereby the flow rate but not blocking the flow path.

A development of the invention provides that the spaced disposition between the outer wall and the valve housing, the spaced disposition between the inner wall and the armature and/or an axial extension of the flow restricting element are selected according to a desired restricting effect of the flow restricting element. The restricting effect of the flow restricting element is dependent upon the ratio of the diameter of the armature with respect to that of the flow restricting element and the ratio of the diameter of the flow restricting element with respect to the valve housing. The axial extension of the flow restricting element is also of importance. By correspondingly embodying the flow restricting element, the restricting effect can be achieved either by guiding the flow restricting element in the valve housing, wherein the flow through-passage is provided between the inner wall and the armature, or at the armature, wherein in this case the flow through-passage is provided between the outer wall and the valve housing. In order to fix the restricting effect of the flow restricting element, at least one of the spaced dispositions and/or the axial extension of the flow restricting element is selected accordingly.

A development of the invention provides that the spaced disposition between the first and the second end stop is smaller than or equal to a stroke of the solenoid valve, in particular of the main stage, and/or that the spaced disposition between the first and the second end stop is greater than or equal to a stroke of the preliminary step. The distance over which the flow restricting element can travel in the axial direction between the first end stop and the second end stop is determined such that it is greater than the stroke of the preliminary stage but smaller than the stroke of the main stage. The term ‘stroke’ is to be understood in each case to be the distance by which the closing element of the preliminary stage and/or of the main stage can be displaced. As a consequence, it is achieved that the flow restricting element is only effective in a hydraulic manner if the preliminary stage and/or its closing element is already in the corresponding open position. Accordingly, the preliminary stage of the solenoid valve is not influenced by the flow restricting element, so that the response time of the solenoid valve (switching time tan and/or tab) is not disadvantageously affected. The restricting effect of the flow restricting element only occurs, in fact, if the preliminary stage is open and the main stage and/or its closing element is to be displaced into the open position. This is achieved, in that the spaced disposition between the end stops is initially greater than or equal to a stroke of the preliminary stage and simultaneously smaller than or equal to a stroke of the main stage of the solenoid valve.

The invention is explained in detail hereinunder with the aid of exemplary embodiments illustrated in the drawing without limiting the invention in any way, in which drawing:

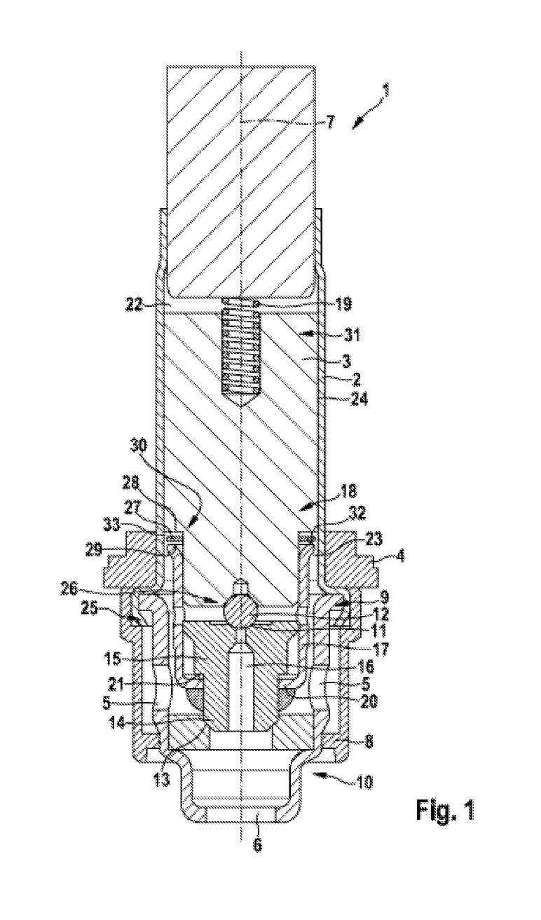

FIG. 1 shows a lateral sectional view of a solenoid valve having an armature and a valve element that respectively embody an end stop, wherein a flow restricting element is arranged between the end stops, and

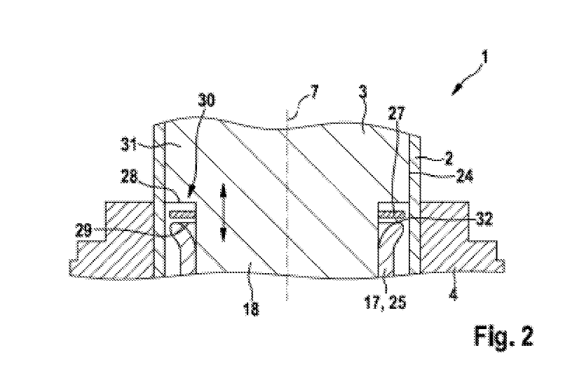

FIG. 2 shows a detailed sectional view of the solenoid valve in the region of the flow restricting element.

FIG. 1 shows a sectional view through a solenoid valve 1. The solenoid valve 1 comprises a valve housing 2 in which an armature 3 is arranged in such a manner that said armature is axially displaceable. FIG. 1 illustrates how the solenoid valve 1 having the valve housing 2 is arranged on and/or fastened to a retaining element 4 of an external device. The solenoid valve 1 comprises a plurality of inlets 5—wherein, alternatively, it is also possible to provide only a single inlet 5—, wherein only two inlets 5 are evident in the figure. The incoming flow to the solenoid valve 1 through the inlets 5 occurs in the radial direction. In contrast thereto, the outgoing flow from the solenoid valve 1 through an outlet 6 is in the axial direction. The term ‘axial direction’ is understood to mean a longitudinal axis of the solenoid valve 1, which is indicated in the figures by the line 7. A filter element 8 is provided in the flow direction upstream of the inlets 5 and said filter element is likewise allocated to the solenoid valve 1.

The solenoid valve 1 is embodied as a two-stage solenoid valve. Accordingly, it comprises a preliminary stage 9 and a main stage 10. A valve seat 11 and a closing element 12 are allocated to the preliminary stage 9, whereas a valve seat 13 and a closing element 14 are allocated to the main stage 10. In so doing, the closing element 14 is part of a valve body 15, on which the valve seat 11 of the preliminary stage 9 is also provided. A fluid duct 16 passes through the valve body in the axial direction and produces a flow connection between the inlets 5 and the outlet 6 when the closing element 12 opens the valve seat 11. However, the fluid duct 16 comprises at least in regions only a comparatively small diameter, so that only a comparatively small quantity of fluid per unit of time can flow through said fluid duct.

In order to fully open the solenoid valve 1, it is therefore in addition necessary that the closing element 14 also opens the valve seat 13. Generally, only the preliminary stage 9 can be opened when there is a high differential pressure between the inlets 5 and the outlet 6. Opening the preliminary stage causes the differential pressure to reduce. Once the said differential pressure has reduced sufficiently, the main stage 10 can also be opened, in that the closing element 14 is displaced out of the valve seat 13. Any displacement of the armature 3 causes the displacement both of the closing element 12 and also of the closing element 14. For this purpose, the closing element 12 is fastened directly to the armature 3, so that in this case a direct operative connection is provided. The operative connection between the armature 3 and the closing element 14 is produced by means of an intermediate piece 17. In so doing, the intermediate piece 17 is embodied at least in regions in a sleeve-like manner and encompasses a lower region 18 of the armature 3 at least in regions. The intermediate piece 17 is fixedly connected to the armature 3 by virtue of said intermediate piece encompassing said lower region of said armature. For example, the intermediate piece 17 is crimped onto the lower region 18.

In the closed position of the solenoid valve 1 illustrated in FIG. 1, the armature 3 is arranged in order to close the valve seats 11 and 13. This means that the closing element 12 sits on the valve seat 11 in a sealing manner and the closing element 14 sits on the valve seat 13 in a sealing manner, so that there is no fluid connection between the inlets 5 and the outlet 6. In order to retain the armature 3 in the closed position, a spring 19 is provided, which spring urges the armature 3 into this position. In this respect, the closed position is a starting position of the solenoid valve 1, so that this represents a de-energized, closed solenoid valve. In order to open the solenoid valve 1, the armature 3 is displaced in the direction of an open position and/or opening position. In so doing, the closing element 12 is initially displaced out of the valve seat 1, so that a fluid connection is provided by way of the fluid duct 16. The closing element 14 initially remains on the valve seat because a guide device 20 of the intermediate piece 17, by means of which an operative connection can be produced between the armature 3 and the closing element 14, is at such a spaced disposition in the axial direction from a counter surface 21 of the closing element 14 that the guide device 20 only comes into contact with the counter surface 21 when the armature 3 is in a position in which the preliminary stage 9 is fully open. Only when the preliminary stage 9 is open and the armature 3 is displaced further in the direction of the open position can the main stage 10 also be opened, in that the closing element 14 is displaced out of the valve seat 13.

A fluid chamber 22 is provided above the armature 3 and a fluid chamber 23 is provided below the armature 3. As the armature 3 is displaced, fluid must be able to pass from the fluid chamber 22 into the fluid chamber 23 and/or in reverse in order to compensate the pressure. For this purpose, a flow path 24 is provided between the valve housing 2 and the armature 3 and/or a valve element 25. The valve element 25 comprises in this case the closing element 14 and also the intermediate piece 17. In contrast, the closing element 12 is allocated to a further valve element 26. In particular, when the solenoid valve 1 is in the pressure-less state, pressure waves can occur by opening and closing the main stage 10 and this causes disturbing noises. These noises occur if the fluid, in order to flow between the fluid chambers 22 and 23, flows along the flow path 24 that comprises a comparatively small cross-section. The fluid is therefore greatly accelerated. If the fluid now impacts a hydraulic stop, then high pressure arises at this site and the disturbing noise occurs.

In order to prevent this, a flow restricting element 27 is allocated to the solenoid valve 1, said flow restricting element being provided in the present embodiment as an annular disk. The flow restricting element 27 is arranged in the flow path 24 and is axially displaceable between a first stop 28 and a second end stop 29. The first end stop 28 is embodied in the case of the present embodiment by the armature 3 and the second end stop 29 is embodied by the intermediate piece 17 and/or the valve element 25. The flow restricting element 27 is guided by virtue of the fact that it fully encompasses the lower region 18 of the armature 3 in the peripheral direction. The first end stop 28 is provided in the form of an annular step 30 on the armature 3. In so doing, the annular step 30 is embodied by a change in the diameter of the armature 3 between the lower region 18 and an upper region 31. Accordingly, the upper region 31 comprises a larger diameter than the lower region 18. In contrast, the second end stop 29 is provided on an end face 32 of the intermediate piece 17 and/or of the valve element 25.

In so doing, the flow restricting element 27 is embodied in such a manner that a flow through-passage 33 is provided between its outer wall and the valve housing 2. This flow through-passage 33 allows the fluid to flow through, wherein the restricting effect of the flow restricting element 27 occurs simultaneously. In order to effect a negative influence of the restricting element 27 on the switching time of the solenoid valve 1, the spaced disposition between the first end stop 28 and the second end stop 29 is selected such that it is greater than or equal to a stroke of the preliminary stage 9. In the case of an embodiment of this type, the flow restricting element 27 generally only comes into contact with the first end stop 28 and/or the second end stop 29 if the preliminary stage 9 is already fully open. Accordingly, the restricting effect of the flow restricting element 27 only prevails for the main stage 10. As a result of the axial displaceability of the flow restricting element 27, said flow restricting element therefore has no influence on a fluid flow between the fluid chambers 22 and 23 at the beginning of a displacement of the armature 3—up to the preliminary stage 9 being fully open as the solenoid valve 1 is opened and/or up to the main stage 10 being fully closed as the solenoid valve 1 is closed—on the contrary, in fact, it renders it possible for the armature 3 to move up and/or down unhindered. Consequently, the reaction time of the solenoid valve 1 remains unchanged.

However, during the further progression of the displacement of the armature 3, the flow restricting element 27 impacts against either the first stop 28 or the second stop 29 and, as a result, causes a hydraulic restricting and/or damping effect. The point in time at which the flow restricting element 27 comes into contact with one of the end stops 28 and 29 can be achieved by virtue of the intermediate piece 17 being purposefully brought against and/or pressed on the armature 3 with a predetermined measurement of the spaced disposition. Naturally, the end stops 28 and 29 can also alternatively be embodied by respective independent elements, for example, by retaining rings fastened to the armature 3. However, it is preferred to embody the end stops 28 and 29 by the armature 3 and/or the intermediate piece 17, because in this manner it is possible to produce the solenoid valve 1 in a simple and cost-effective manner without additional parts (except for the flow restricting element 27). When producing and/or assembling the solenoid valve 1, the spaced disposition between the end stops 28 and 29 is achieved by correspondingly selecting the axial extension of the intermediate piece 17. Said spaced disposition is selected such that, after adjusting the stroke of the preliminary stage 9, the required displaceability of the flow restricting element 27 is ensured.

FIG. 2 illustrates a detailed sectional view of the solenoid valve 1 in the region of the flow restricting element 27. The embodiment illustrated in FIG. 2 corresponds to the embodiment illustrated with the aid of FIG. 1. Reference is made in this respect to the aforementioned explanations.

1. A solenoid valve comprising:
an armature that is arranged in an axially displaceable manner in a valve housing;
at least one valve element that is operatively connected to the armature; and
a flow restricting element,
wherein the at least one valve element is displaceable by means of the armature to open or close at least one valve seat of the solenoid valve,
wherein at least one flow path is embodied between the valve housing and the armature and/or the at least one valve element,
wherein the flow restricting element is provided in the flow path and is arranged between a first end stop and a second end stop,
wherein the first end stop includes the armature, and
wherein the second end stop includes the at least one valve element.

2. The solenoid valve as claimed in claim 1, wherein:
the at least one valve element comprises at least one closing element that is allocated to the valve seat, and
an intermediate piece of the at least one valve element produces an operative connection between the armature and the closing element.

3. The solenoid valve as claimed in claim 2, wherein:
the at least one valve element comprises a plurality of closing elements, and
each closing element is configured to open or close a valve seat respectively.

4. The solenoid valve as claimed in claim 2, wherein one of the closing elements is allocated to a preliminary stage and another one of the closing elements is allocated to a main stage of the solenoid valve.

5. The solenoid valve as claimed in claim 2, wherein the intermediate piece encompasses the armature at least in regions and/or is fastened thereto.

6. The solenoid valve as claimed in claim 1, wherein the flow restricting element includes an annular disk.

7. The solenoid valve as claimed in claim 1, wherein:
the first end stop includes an annular stage of the armature, and/or
the second end stop is provided on an end face of the intermediate piece.

8. The solenoid valve as claimed in claim 1, wherein the flow restricting element comprises a flow through-passage between its outer wall and the valve housing and/or between its inner wall and the armature.

9. The solenoid valve as claimed in claim 1, wherein (i) a spaced disposition between the outer wall and the valve housing, (ii) the spaced disposition between the inner wall and the armature, and/or (iii) an axial extension of the flow restricting element are selected according to a desired restricting effect of the flow restricting element.

10. The solenoid valve as claimed in claim 9, wherein:
the spaced disposition between the first and the second end stop is smaller than or equal to a stroke of a main stage of the solenoid valve, and/or
the spaced disposition between the first and the second end stop is greater than or equal to a stroke of a preliminary stage.
